(19) United States
(12) Patent Application Publication
(10) Pub. No.: US 2010/0315654 A1
(43) Pub. Date: Dec. 16, 2010

(54) LIDAR Instrument System and Process

(76) Inventor: Marcia Jada Berger, Wayland, MA (US)

Correspondence Address: Marcia J. Berger;ABC Soils, Inc., SUITE 211, 111 BOSTON POST ROAD, Sudbury, MA, 01776, US

(21) Appl. No.: 12/813,383

(22) Filed: Jun. 10, 2010

Related U.S. Application Data
(60) Provisional application No. 61/213,467, filed on Jun. 11, 2009.

(51) Int. Cl. G01B 11/14

(52) U.S. Cl. 356/625

(57) ABSTRACT

An apparatus and systems used to measure the height of a liquid in a well or a tank and in particular to those apparatus and systems which use coherent light or laser for such measurement. The apparatus and systems will also measure respective elevations of multiple overlying immiscible fluid layers. The method entails generating coherent light or laser beams and the timing of its travel to either a liquid surface or floating object and its return to a receiving sensor. The timing of the receipt of the signals is processed to determine the relative height of a fluid surface in a chemical or fuel tank or groundwater well. The apparatus and systems provide multiple improvements over current methods of measuring fluid levels in wells and tanks. Improvements include increased accuracy due to reduction in human error when making measurements and elimination of environmental hazards involving the release and spreading of contaminants in soil and groundwater as can be caused by several current measurement methods.

### FIELD OF INVENTION

The present invention relates to apparatus and systems used to measure the height of a liquid in a well or a tank and in particular to those apparatus and systems which use a laser for such measurement. The height of the top of groundwater and height of individual layers of separate phase immiscible pollutants in wells is necessary information for assessing and cleaning up subsurface contamination, such as from leakage of oil and industrial wastes.

In surveying the top of groundwater elevations and slopes over a given geographical area for environmental, oil and water supply monitoring purposes, test wells are drilled and utilized. Similar data are also sometimes obtained from extraction wells, water wells and fuel supply wells. Well diameters typically range from 0.75 inches to 24 inches in diameter, and typically range in depth from between five to several hundred feet, with groundwater ranging in depth from zero to several hundred feet.

The ability to accurately measure the height of single and multi-layer liquids in a tank is needed in order to determine respective volumes of fluids contained in the tank which is necessary for process control, leak detection, overfill protection and tracking of inventory. The presence of separate phase water in a fuel or chemical tank or missing fuel can be used as an indication of a tank leak or undesired water infiltration.

### DESCRIPTION OF THE PRIOR ART

In known methods for measuring fluid levels in wells, a sensor is lowered down the well casing until it contacts water, at which point an indicator light is illuminated on the sensor's spool indicating that the sensor has contacted the surface of the water. At this point, a measurement of wire length deployed to lower the probe is read. Alternatively, a tape measure is lowered into the well covered with water sensitive paste and then retrieved to directly read depth to the water. This is how groundwater elevation is determined. Given a geographical area with three or more wells, the groundwater elevation gradient and flow direction can be determined based on Darcy's Law. For the information to be most meaningful, the measurement generally should be within 0.01 foot tolerance.

There are numerous problems with the known system of measuring the top of fluid elevations within wells. The wire used to lower the probe develops kinks and bends that cannot be adequately straightened for the degree of accuracy required during measurement and reading.

Another problem with the sensor is that any film or pollutants floating on the surface of the well water can coat the sensor and prevent it from activating when it reaches the water surface. The materials may also cause the probe to stay activated, not allowing for the exact point of entry to be found and measured.

In addition, the physical contact with the groundwater introduces the possibility of spreading undesirable elements, such as iron bacteria or pollutants, from one location to the next, and for its prevention, necessitates decontaminating the equipment between each measurement.

There is also a significant human error factor introduced by having to interpolate between notches along the wire or tape to the desired precision, and by sometimes incorrectly interpolating to a lower or higher inch for the reading. This latter error occurs because along a wire there is typically a printed whole number at each full marking, but no labeling of the notches in between.

Many of the wells relied on for water elevation readings are constructed of PVC which is usually cut to size in the field. The top of a well casing is depended upon as vertical survey reference control point, despite its uneven construction. The unevenness of the wall casings weakens the integrity of these control points, thereby introducing possible errors in measurement accuracy. In addition, for various reasons, well casing tops are sometimes positioned below the ground surface, which prevents a clear view to determine where the top of the casing ends up along the wire.

There are also numerous problems with known systems for measuring both the top of fluid elevations and thicknesses of overlying layers of immiscible fluids in wells, such as oil floating on waters. The known measuring devices require vertical space in which to operate, which thereby eliminates the ability of the meters to measure thin product layers. The known measuring devices also require a considerable amount of room, thereby causing the liquid layer in which the device is immersed to be pushed up the well, resulting in larger than actual product layer thickness and higher elevation measurements.

The majority of the sensors on the market are electrically activated, that is, the water bridges the gap between two electrodes in a pen-shaped probe, effectively closing the circuit. In more expensive probes, the sensor is optically activated and enables the detection of a change in the angle of refraction to differentiate between hydrocarbon-based fluids and water.

Many of the problems and disadvantages are also present when measuring fluid depths in storage tanks or other tanks by means of immersed sensors or by “sticking the tank” i.e. putting a calibrated stick, such as a long ruler into the tank until it contacts the tank bottom and reading the highest liquid level on the stick. Using the sensor method, the immersed sensors must be regularly cleaned of mineral deposits and various chemicals, and many sensors eventually corrode and require replacement. Sensors in various stages of corrosion and undergoing deposition frequently yield erroneous measurements. Repeatedly sticking a tank often results in failure of that tank at the bottom where it is repeatedly hit by the measuring stick.

Apparatus and methods are known to measure water levels, such as disclosed in the following references.

U.S. Pat. No. 3,933,042 to Rector et al. discloses a water level gauge for use in rivers, streams, bays, etc., which includes a pair of capacitance probes at a predetermined spaced relationship to which an electrical signal is applied for measuring the capacitance between the probes dependent upon the amount of liquid in the well.

U.S. Pat. No. 4,387,594 to Berthold discloses a water level indicator having a remote and a local readout display for use with a boiler drum, which includes an optical means for providing an optical signal of the liquid level in a boiler, which signal is split by a beam splitter and transmitted to a fiber optic cable to a display for a reading the water level of the boiler.

U.S. Pat. No. 4,621,264 to Yashiro, et al. discloses a method and apparatus for measuring water level in a well consisting of a transmitting electrode and a receiving electrode mounted to a boring drill rod and a casing pipe, respectively a pulse oscillator for generating a pulse-modulated electromagnetic wave, and a spectrum analyzing means for measuring delay time between the transmitted pulse and received pulse and recording means for recording the measured data.

A process is known to measure fluid depth in tanks by a remote method which employs sonar. The sonar method does not allow for the measurement of individual product layer thicknesses. In addition, sound waves emitted as part of the sonar technology rebound off the walls of the enclosed spaces and the residual fluid coating the walls, thereby limiting the accuracy of this method of measurement. This sonar method is disadvantageous for this rebound effect and not effective for measuring water level within wells.

The present invention is configured to provide consistent positioning of the instrument relative to the well casing, such as by including a separate attachment to each well casing top. The invention improves the reliability of the surveyed reference control points and upgrades the accuracy of the water elevation measurements by eliminating the disadvantages of the known devices and systems.

### SUMMARY OF THE INVENTION

The LIDAR instrument of the present invention consists of a laser or another source of coherent light which functions as a sensor for measuring the height of liquid in wells or tanks. In addition, the device provides for measuring the thickness of respective layers of immiscible fluids in the well or the tank. The invention consists of a source for sending and receiving measuring light, a mounting assembly for securing and retaining the measuring light source; a timer, a processor, an aligning and/or leveling mechanism; and a well head assembly for removable mounting of the device to the well head.

A tank hatch assembly is provided in lieu of a well head assembly for removable mounting of the LIDAR instrument to a tank.

The LIDAR system according to the present invention may also be used for leveling of the system. That is, since the ground water surface defines a horizontal plane, light directed to the ground water surface at different angles would provide sufficient directional information to be used by the LIDAR instrument to be self-leveling. This embodiment would obviate the need for a collar, as the steadying or leveling of the LIDAR instrument will depend from established and identified reference points.

The reference points can be identified by, for example, a screw-clip, or an indentation that a removable pin is disposed in and that is installed on a side of the well casing to which the LIDAR instrument may be affixed. Alternatively, the well casing attachment may be of material detectable by a homing device to function as a elevation reference point that the LIDAR instrument is adjacent to, although not in contact with. Further, the LIDAR instrument may be connected to a homing device by a wire, tube or optical fiber.

Therefore, another embodiment of the present invention calls from a LIDAR instrument system consisting of a source for sending and receiving measuring light; an instrument connection point or homing device along with fixed connecting points relating the instrument to a fixed elevation reference point at each well head or tank. The fixed elevation reference point at the measuring location may be an indentation at the well head or tank to house a removable pin or clip, which pin or clip interconnects with an attachment on the instrument or a signal point for a homing device for removable mounting of the device to the well head; and an aligning and/or leveling mechanism. The leveling mechanism may also be LIDAR based, and utilize a horizontal plane defined by the liquid surface in the well or tank.

Multiple layers of liquid in wells and tanks will be identified by differing angles of refraction or reflection of the light signals reflected back to the receiver.

The present invention also sometimes includes placing floating, reflective objects of differing specific gravities in wells and tanks to serve as points of reflection and identify the height of fluid column in wells and tanks.

### DESCRIPTION OF THE DRAWINGS

For a more complete understanding of the present invention, reference may be had to the following drawing taken in connection with the description of the preferred embodiments, of which:

FIG. 1 is a view of the LIDAR apparatus/system according to the present invention for use at a well head.

FIG. 2, located on the same sheet as FIG. 1 is a view of the LIDAR apparatus/system according to the present invention for use at a tank.

FIG. 3 is a view of a process for measuring liquid parameters with LIDAR apparatus/system according to the present invention.

### DETAILED DESCRIPTION OF THE PREFERRED EMBODIMENTS

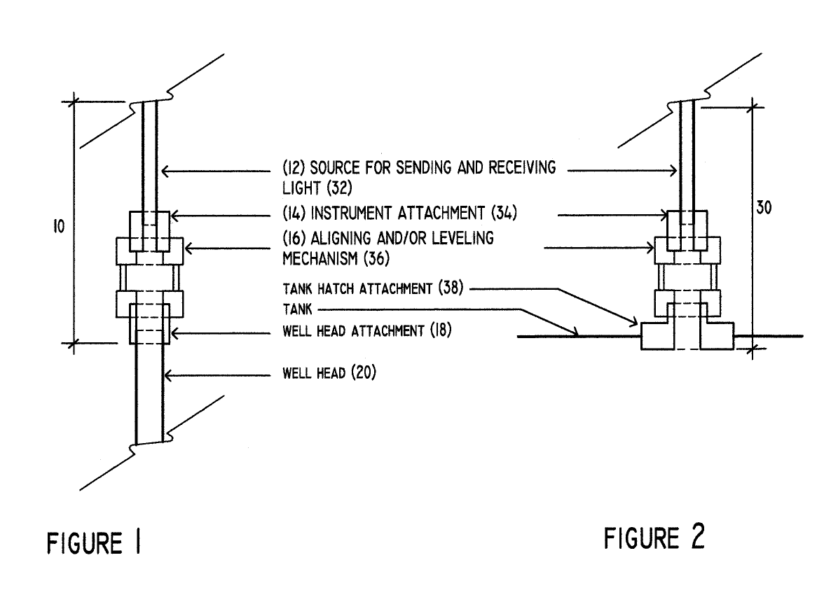

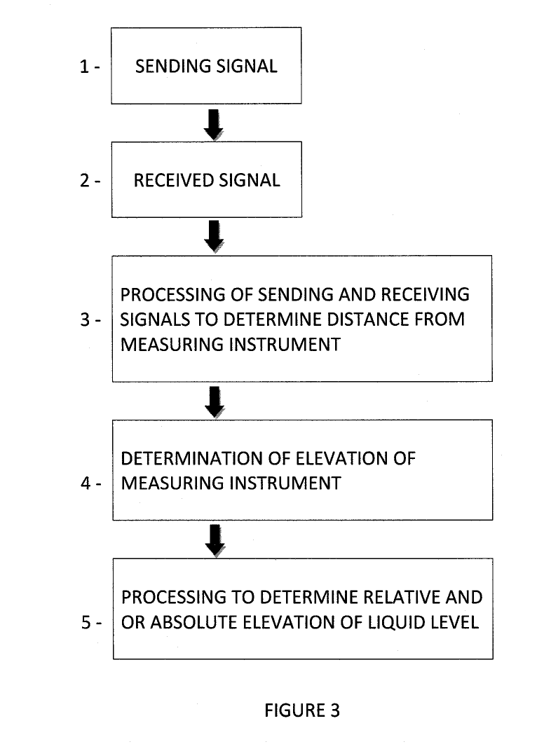

1 LIDAR (light detection and ranging) instruments transmit pulses of light energy from a laser to measure the speed and amount of light that returns. The signal's round trip time is a direct measure of the distances to an object.
2 For purposes of the present invention and disclosure herein, the LIDAR instrument is also used to measure other parameters of a liquid in a well or tank.
3 The present invention is a laser used as a sensor for measuring the elevation of liquid in a tank or well. The apparatus permits measurements to be taken in a virtually noninvasive manner from the top of the well without the need for lowering a wire into the well hole and thereby eliminating the possibility of bending the wire, with commensurate loss of accuracy. Moreover, no deposits are left on the sensor which, with the known devices, can confound or destroy the value of “apparent” data. In addition, the potential for cross-contamination between well locations is avoided. This present invention is less time consuming for gathering well liquid elevation data. A floating reflective device may be added in certain liquids to aid in reflecting the light signals back to the signal receptor.
4 The invention may be configured to provide consistent seating over the well casing, which involves a separate attachment to each well casing top, thereby improving the reliability of the surveyed reference control points and in turn upgrading the accuracy of the water elevation measurements. Human errors, introduced by incorrect readings of the measuring wire in known devices, are eliminated when using the present invention which includes a digital readout. Information from the digital readout is stored and processed within the apparatus or transmitted to a portable computer, for example.
5 With the present invention, using one or more sensor(s), along with one laser or a series of multispectral lasers or other light source(s) enables measuring the thicknesses of layers of immiscible fluids in wells and tanks.
6 A laser or another source of coherent light used in the present invention functions as a sensor for measuring the depth of fluid in tanks or other containers. Such a device allows measurements to be taken in a noninvasive manner from a point above the fluid level without the need for immersing a sensor into the fluid, thereby eliminating the corrosion of and deposition of matter onto immersed sensors. The present invention is more accurate than the known sonar technology. The apparatus can also be used in conjunction with a switch.
7 The apparatus of the present invention, by connecting the sensor, which includes a laser or series of multispectral lasers or other light sources, to either a portable computer or dedicated data processor that is part of the device, will analyze the spectra of the return signal to determine the presence of pollutants floating on the surface of the water and possibly determine their chemical compositions.
8 FIGS. 1, 2 show the LIDAR apparatus/system of the present invention used at a well head and a tank, respectively.
9 The LIDAR instrument of the present invention for use with a well head is shown generally at 10 in FIG. 1. The apparatus 10 includes a source for sending and receiving measuring light 12 which is releasably received with an instrument attachment 14. The attachment 14 is used to interconnect the measuring light source 12 with an aligning and/or leveling mechanism 16 for the laser. The leveling mechanism 16 is in turn attached to a well head attachment 18 which is releasably engageable with the well head 20.
10 A second embodiment of the LIDAR instrument according to the present invention is shown generally at 30 in FIG. 2.
11 The LIDAR instrument 30 of the present invention is for use with a tank 40. The apparatus 30 includes a source for sending and receiving measuring light 32 which is releasably received in an instrument 34. The attachment 34 is used to interconnect the measuring light source 32 with and aligning and/or leveling mechanism 36 for the laser. The leveling mechanism 36 is in turn attached to a tank hatch attachment 38 which is releasably engageable with the tank.
12 The attachments 14, 18, 34 and 38 can be structured as, for example, a collar. However, it is understood that other constructions for these elements can be used with the present invention.
13 Referring to FIG. 3, there is shown a flow chart 50 for a process of using the LIDAR apparatus of the present invention. The process 50 of the present invention can be employed with wells or tanks.
14 The present invention may emit pulses of light and simultaneously send a charge to a capacitor. The remaining charge in the capacitor will be proportional to the time of the pulse, and measured when the energy wave returns to a sensor. Multiple measurements could be averaged for greater precision. The apparatus may also emit light at multiple angles and transmit multiple pulses and/or have multiple sensors to improve precision.
15 The device, process and system according to the present invention is aligned to a control position for each well head or tank for which measurements are to be taken. Accordingly, six (6) degrees of direction i.e., x,y, and z coordinates and the three (3) angles of “attack” of the LIDAR beam, must be fixed or defined in a space relative to a fixed control or standard position for each well head in order to achieve proper measuring position (a tolerance to within the nearest 0.01′).
16 According to the present invention, this may be accomplished by mounting the LIDAR instrument on, for example, a flat surface such as a machined longitudinal member of metal which is mounted on a stand or on a collar on the well head; or mounting the LIDAR instrument to a notch or “lock and key” mount on the well head. The exact position of the device is adjustable with a plurality of micrometer screws so that each one of the six degrees of movement can be adjusted precisely with respect to each other for the LIDAR measurement.

The position of the present invention is then arranged. In one embodiment, a GPS (global positioning satellite) receiver may be used as an absolute positioning standard for the LIDAR device of the present invention. If the mount for the device is sufficiently sized, the corners of the longitudinal mount can be adjusted to position the device along the x, y and z axis, as well as the additional angles of attack for the LIDAR beam.

Another embodiment includes a laser which is positioned/fixed on the LIDAR mount at each well head. A mirror adjustable with micrometer screws, for example, is positioned on a pole or other fixed mounting device and disposed proximate to the site of measurement. The mirror is mounted to reflect the laser signal back to the well head. A sensor is mounted on the well head, and is constructed and arranged to detect interference patterns of the reflected light, if such light is out of phase with the initial laser signal. Only precise positioning of the system will prevent interference if the mirrors are positioned properly prior to the first measurement and the position is then replicated for subsequent measurements.

With respect to determining the elevation of the LIDAR instrument, the following is provided:
1. Fixing a removably mountable or permanent fastener of any number of constructions to the well head in order to attach the LIDAR instrument to the well head in a consistent and reliable manner for establishing an elevation reference point. A correction would then be made to establish the instrument elevation;
2. Establishing a manometer to a fixed reference point at a position proximate to one or a plurality of wells to be tested. The manometer includes a liquid-filled tube that is mountable to a reservoir located on a LIDAR instrument. The manometer indicates height of the LIDARE instrument as it is raised and lowered with respect to the well;
3. Fixing a calibrated tube filled with a plurality of fluids of varying densities to the LIDAR instrument, which tube has a wire at a portion thereof and a microfilter midway of the tube. A timer is included. As the calibrated tube is raised and lowered, the liquids of varying densities move differently, thereby causing a rising of higher density liquid into the lower density later. The more dense liquid passes through the microfilter and breaks up into a plurality of small bubbles. As the bubbles move to a top of the tube, the resistivity change along the wire is measured as are time adjustments to thereby measure the change in elevation;
4. A reflecting substance or member, such as silver paint or a small nail (or other object that reflects light differently than surrounding materials), is affixed to each monitoring well to function as a survey reference point. The LIDAR instrument transmits a beam to the reflecting device and receives the reflected signal as well. In this manner of operation, elevation of the LIDAR instrument is determined;
5. One of a plurality of light conducting fibers are affixed to each monitoring well or tank to function as a survey reference point. The LIDAR instrument transmits a beam into the fiber and receives a return signal. In this manner of operation, elevation of the LIDAR instrument is determined.

It will be understood that the embodiments described herein are merely exemplary and that a person skilled in the art may make many variations and modifications without departing from the spirit and scope of the invention. All such modifications and variations are intended to be included within the scope of the invention as described herein.

1. A device/apparatus/system based on the use of laser/coherent light and the elapsed time necessary to measure a reflected signal from above a liquid surface to accurately measure the height of a column of liquid in a well or tank.

2. A device/apparatus/system which uses LIDAR to measure a reflected signal from above a liquid surface to measure the height of a column of liquid in a well.

3. A device/apparatus/system which uses the nature of the reflected light to measure the thicknesses of overlying layers of immiscible fluids in a well.

4. A device/apparatus/system which uses the nature of the reflected light to identify differences in compositional characteristics of the material in the well relative to water to the extent of being able to measure relative heights of overlying layers of immiscible fluids.

5. A process based on the use of coherent light and the elapsed time necessary to measure a reflected signal from the surface to accurately measure the height of a column of liquid in a well.

6. A process which uses the nature of reflected light to identify differences in compositional characteristics of the material in the well relative to water to the extent of being able to measure relative heights of overlying layers of immiscible fluids.

7. A process which uses the nature of the reflected light to measure the thicknesses of overlying layers of immiscible fluids in a well.

8. A device/apparatus/system based on the use of coherent light and the elapsed time necessary to measure a reflected signal from the surface to accurately measure the depth of liquid in a stationary tank.

9. A device/apparatus/system which uses LIDAR to measure a reflected signal from the surface to measure the depth of liquid in a stationary tank.

10. A device/apparatus/system which uses the nature of the reflected light to measure the thicknesses of layers of immiscible fluids in a stationary tank.

11. A device/apparatus/system which uses the nature of the reflected light to identify differences in compositional characteristics of the material in the well relative to water to the extent of being able to measure relative heights of overlying layers of immiscible fluids.

12. A process based on the use of coherent light and the elapsed time necessary to measure a reflected signal from the surface to accurately measure the depth of liquid in a tank.

13. A process which uses LIDAR to measure a reflected signal from the surface to measure the depth of liquid in a tank.

14. A process which uses the nature of the reflected light to identify differences in compositional characteristics of the material in the well relative to water to the extent of being able to measure relative heights of overlying layers of immiscible fluids.

15. A process which uses the nature of the reflected light to measure the thicknesses of overlying layers of immiscible fluids in a tank.

16. A device/apparatus/system based on the use of coherent light and the elapsed time necessary to measure a reflected signal from the surface to measure the depth of liquid in a tank for use in conjunction with a switch.

17. A process based on the use of coherent light and the elapsed time necessary to measure a reflected signal from the surface to measure the depth of liquid in a tank for use in conjunction with a switch.

18. A process which uses LIDAR to measure a reflected signal from the surface to measure the depth of liquid in a tank for use in conjunction with a switch.

19. A process which uses LIDAR to measure a reflected surface in conjunction with other parameters including but not limited to tank dimensions and temperature to detect and measure a rate of leakage from a tank.

20. A device/apparatus/system based on the use of laser/coherent light and the elapsed time necessary to measure a reflected signal from above a reflective object floating on a liquid surface to accurately measure the height of a column of liquid in a well or tank.
